(19) United States
(12) Patent Application Publication
(10) Pub. No.: US 2026/0166637 A1
(43) Pub. Date: Jun. 18, 2026

(54) METHOD FOR TOOTHING MACHINING WITH SUBSEQUENT CHAMFERING

(71) Applicant: GLEASON-PFAUTER MASCHINENFABRIK GMBH, Ludwigsburg (DE)

(72) Inventors: Johannes Brogni, Dotzigen (CH); Markus Krömer, Lyss (DE); Ralf Schmezer, Ludwigsburg (DE)

(21) Appl. No.: 19/127,452

(22) PCT Filed: Nov. 6, 2023
(86) PCT No.: PCT/EP2023/080880

§ 371 Date: May 6, 2025

(30) Foreign Application Priority Data
Nov. 7, 2022 (DE) 10 2022 004 131.6

(51) Int. Cl. B23F 1/06

(52) U.S. Cl. CPC B23F 1/06

(57) ABSTRACT

The invention relates to a method for toothing machining, in which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, the axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, the predominant directional component of the feed movement runs in the direction of the tool axis of rotation, and the cutting edge has a greater directional component in the direction of the axis of rotation of the chamfering tool than in the plane of rotation orthogonal thereto, at least in its portion chamfering in the region at half the tooth height of the workpiece toothing.

### The invention relates to a method for toothing machining with subsequent chamfering.

It is well known in technology to chamfer toothings, after they have been machined, at the tooth end edges. For example, if the end face of the gear is to serve in subsequent operations as a planar cutting or defining surface, its planarity would be disturbed by the burr. Furthermore, after hardening, a burr poses the risk that it will break off when the gear later runs in a gear mechanism, and cause damage to the tooth flanks or gear mechanism components. Apart from this, such a burr also poses a risk of injury when handling the toothing or the toothed workpieces. If only the burr is removed and the tooth edge itself is not machined, there is a risk of the latter becoming glass-hard due to over-carbonization during hardening, and then breaking under stress.

Numerous different chamfering methods have been developed to counteract this disadvantage. In a method disclosed in EP 1 279 127 A1, material of the workpiece in the region of the tooth edge is displaced by a chamfering wheel rolling in toothed engagement therewith. The secondary burrs (material build-up) created during this so-called rolling deburring or rolling pressure deburring must also be removed afterwards. DE 10 2009 018 405 A1 teaches how such secondary burrs can be suitably removed.

As an alternative to this chamfering by plastic pressing, it is possible to create a chamfer on the tooth edge by cutting. According to DE 10 2009 019 433 A1, a substantially cylindrical machining tool which has at least one cutting edge is clamped on a tool spindle.

DE 10 2013 012 797 A1 discloses a method that also works in a cutting manner, wherein the chamfering wheel is substantially similar to a skiving wheel, and an additional angle of inclination is set based upon the standard configuration of the skiving engagement. The axis distance set here corresponds in magnitude to the sum of the workpiece radius and the tool radius, and the chamfering can be carried out with a feed movement that is predominantly parallel to the workpiece axis or can be integrated into the chamfering tool via a special design of the chamfering tool. The chamfering process described in the non-patent literature, “Advances in Manufacturing Engineering and Materials,” pp. 18-26, also works with a feed movement parallel to the workpiece axis, in which a workpiece-specific chamfering tool machines both tooth end edges of a tooth gap simultaneously, and a component of the cutting speed parallel to the workpiece axis is directed towards the axial toothing center on one edge and away from the axial toothing center on the other edge.

Another cutting chamfering process (so-called “chamfer-cut milling”) with a workpiece-specific chamfering tool, the profile of which is designed in such a way that, when a chamfering milling tooth passes through a tooth gap in the workpiece toothing, the latter is completely chamfered on both flanks of the tooth gap, is disclosed in DE 10 2013 015 240 A1. These “chamfer-cut millers” look similar to a hob, but the flight circles of the same profile regions overlap. A further cutting chamfering operation more closely oriented to gear hobbing is described in DE 10 2018 001 477.

According to a principle similar to the “chamfer cut miller” disclosed in DE 10 2013 015 250 A1, there is also a fly cutter-like removal on the tooth edge, used to create a bevel, e.g., for gear mechanism toothings, in which rotating fly cutters, realized for example in the form of an end mill, are lined up with their tool rotational axis in such a skewed manner to the axis of the workpiece toothing that a tooth flank of the workpiece toothing is machined in a single pass through the machining zone by a cutting process parallel to the final geometry to be produced. Such a process is described for example in the non-patent literature, T. Bausch, “Innovative Zahnradfertigung,” Expert-Verlag, 3rd edition, on p. 323.

The method disclosed in DE 10 2014 218 082 A1 is similar to the gear skiving chamfering of DE 10 2013 012 797 A1, but a skewed axis configuration is already structurally integrated into the toothing machine.

Yet another chamfering technique has become known from DE 10 2018 108 632A1, in which a pin milling cutter is moved along the tooth edge by machine axis movement-a chamfering technique that is particularly suitable for front edges that cannot be easily reached using “chamfer-cut millers” or hobbing-type tools due to interfering contours on the workpiece.

WO 2019/017248 A1 proposes using a pressing process such as roller pressure deburring, but shifting the weight of the secondary burr generation away from the tooth flank in the direction of the end face.

In terms of arrangement, it has become known from EP 1 495 824 A2 to place the machining tools used for chamfering the tooth edges on the same shaft as a hob used to produce the workpiece toothing.

All of these chamfering techniques have their advantages and disadvantages. The invention is based upon the object of providing a toothing machining with subsequent chamfering, which in particular achieves a satisfactory combination of suitability for machining workpieces with interfering contours and simplicity of the process design.

This object is achieved in terms of process engineering by a method for toothing machining, in which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, the predominant directional component of the feed movement runs in the direction of the tool axis of rotation, and in particular the cutting edge has a greater directional component in the direction of the axis of rotation of the chamfering tool than in the plane of rotation orthogonal thereto, at least in its portion chamfering in the region at half the tooth height of the workpiece toothing.

This combination of axis crossing angle adjustment, feed movement and cutting position configuration, as well as axial distance restriction ensures that a chamfer can be machined in a continuous process even in the vicinity of an interfering contour and thus also in a time-saving manner, unlike in cases of predominantly axial feed movement or a pin milling cutter chamfering, in which the chamfering tool is moved along the tooth edge, as in form milling.

In a preferred method design, it is provided that the tooth end edge other than the tooth end edge of the same tooth gap chamfered with the chamfering tool be chamfered with an additional chamfering tool which is driven rotationally by a third tool spindle.

This variant has the advantage, due to the additional chamfering tool, that a coupling of the machining of both tooth end edges of a tooth gap is eliminated, and thus a machining offset is eliminated based upon the (even if small) difference in time in the successive machining of both tooth edges, mediated via the workpiece rotation.

In this connection, it is also preferably provided that the directional component of the cutting speed parallel to the workpiece axis be directed away from the axial center of the workpiece toothing (i.e., from the flank) (in the direction of the machined front side) when chamfering with the chamfering tool and/or the additional chamfering tool, preferably when chamfering with both tools. This reduces the risk of secondary burrs forming on the tooth flanks.

In a further preferred embodiment, it is provided that the chamfering be controlled with the same control device as the toothing machining with the toothing machining tool. This design is also considered worthy of protection, irrespective of the question of the feed movement. The invention thus also relates to a method for toothing machining, in which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, in particular the cutting edge has a larger directional component in the direction of the axis of rotation of the chamfering tool than in the plane of rotation orthogonal thereto, at least in its portion chamfering in the region of the tooth heads of the workpiece toothing, and wherein the chamfering is controlled with the same control device as the toothing machining with the toothing machining tool.

The control device is therefore not a separate control device directed solely at the chamfering and which receives external input, but, rather, already internally has the control parameters of the previous toothing production or machining, including any setting changes made within a batch. This increases the safety and reliability of the chamfering method.

In this connection, it is preferably provided that at least one control parameter of the chamfering be incorporated into the chamfering as a function of a change in a control parameter of the toothing machining with the toothing machining tool. This increases the flexibility of the method.

In a further preferred embodiment, it is provided that the control parameter influence the course of the transition line between tooth flank and chamfer during chamfering, taking into account an allowance to be removed in a subsequent hard finishing operation compared to a final geometry of the workpiece toothing.

This increases the final accuracy of the chamfer after subsequent hardening and hard finishing by taking into account in advance how the transition line changes in its course due to hard finishing. The settings made are preferably such that the transition line is parallel to the front edge surface in the final geometry after hard finishing. The workpiece-specific profiling of the chamfering tool can be determined, for example, by back-transformation of a given transition line (after chamfering) with a given axial kinematics.

In a further preferred embodiment, it is provided that the chamfering be carried out in the continued presence of a cooling and/or lubricating fluid originating from the toothing machining by the toothing machining tool. This is preferably a semi-wet machining process in the sense that, although no additional lubricant/fluid is used during chamfering, cooling and/or lubricating fluid from the previous toothing machining still wets the workpiece.

In a further preferred embodiment, burrs created by chamfering are removed with an additional burr removal device, in particular a brush. Such secondary burrs can arise in particular in the case of helical-toothed workpieces with a larger helix angle; in combination with the previously mentioned preferred uniform cutting direction component parallel to the workpiece axis during chamfering, a burr-free chamfered workpiece can be provided in particular simply by using a brush acting in the region of the end face.

In a further preferred embodiment, it is provided that the control device control the chamfering to produce a course of the transition line between chamfer and flank that deviates from parallelity to the end face. The differing course is preferably controlled in such a way that, as explained above, the parallelity is restored after hard finishing. This aspect of the invention is also considered advantageous and worthy of protection, irrespective of the course of the feed movement.

The invention thus also relates to a method for toothing machining, in which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, in particular the cutting edge has a larger directional component in the direction of the axis of rotation of the chamfering tool than in the plane of rotation orthogonal thereto, at least in its portion chamfering in the region of the tooth heads of the workpiece toothing, wherein the control device controls the chamfering to produce a course of the transition line between chamfer and flank that deviates from parallelity to the end face.

In one possible embodiment, it is provided that the axis crossing angle be adjustable, in particular via a rotary axis, in particular NC-controlled.

In a further expedient embodiment, it is provided that the second and the third tool spindles be carried by a common carrier, which in particular has at least two degrees of freedom of movement.

The chamfering described above is applicable for external toothings. However, it is also intended for chamfering internal toothings. For this purpose, a spindle head with an angle gear mechanism is preferably provided for the chamfering tool.

This method variant for internal toothing machining is also considered advantageous, irrespective of the question of how the feed movement is to be/can be carried out, and is considered worthy of protection on its own. The invention thus also relates to a method for toothing machining, in which, on a toothing machine controlled by a control device, an internal toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined internally toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece internal toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, in particular the cutting edge has a larger directional component in the direction of the axis of rotation of the chamfering tool than in the plane of rotation orthogonal thereto.

The internal toothing machining variant thus defined can be combined with the above-mentioned aspects of the chamfering.

In a preferred design in this regard, with respect to the device, two degrees of freedom of movement for chamfering are provided, in particular two linear degrees of freedom of movement, one of which has a predominant directional component parallel to the workpiece axis of rotation and another of which has a predominant directional component radial to the workpiece axis of rotation. Preferably, these are realized via a cross-carriage arrangement.

The method could be carried out on a horizontal machine (horizontal workpiece axis of rotation). In this case, linear axes for moving the main machining tool on the one hand and for positioning the chamfering tool on the other are preferably provided on opposite sides of the workpiece axis of rotation. Furthermore, the chamfering tool preferably points with its tip towards the side of the linear movement axis on the chamfering side, which axis preferably runs parallel to the workpiece axis of rotation. In a further preferred embodiment, the internally toothed workpiece is clamped onto a workpiece spindle, wherein the clamping provides an axial distance between the axial end side, close to the clamping, of the internal toothing and the spindle end region, located within the internal toothing in a projection orthogonal to the workpiece axis of rotation, and pointing axially in the direction of the axial end side, remote from the clamping, of the internal toothing. In this way, a chamfering head carrying the chamfering tool can be moved axially deep into the internal toothing in order to chamfer the end side of the internal toothing closest to the clamping even without changing the clamping.

A direct drive could be used as a rotary drive for the chamfering tool. Preferably, however, an indirect drive and a drive force transmission are realized by means of a gear mechanism, in particular an angle gear mechanism; a simple belt transmission is also conceivable.

When implemented using a vertical machine (vertical workpiece axis of rotation), a variant is considered in which a machining head for the main machining carries the machining head for the chamfering process in piggyback fashion. In this variant, the chamfering head receives all the movement axes that are available to the main machining head, and these can be used as positioning axes, infeed axes, and also feed axes. In a further preferred variant, the chamfering tool is additionally arranged so as to be displaceable orthogonally to its axis of rotation relative to the main machining head. The displacement axis can be implemented as an NC axis or as a simple adjustment axis, e.g., to move the machining tool between a retracted position and a working position—for example, with a predominant directional component parallel to the axis of rotation of the main machining tool. However, a defined angle setting of this travel axis relative to the tool axis of rotation of the main machining is also considered, so that the chamfering machining takes place in a configuration in which the tool axis of rotation of the main machining tool and the workpiece axis are at an axis crossing angle that is selected to be large enough that there is no collision between the main machining tool and the workpiece while the chamfering machining is in progress. This variant is also conceivable in combination with the variant of the chamfering tool that can be moved relative to the main machining head.

In other designs, the chamfering head could be provided and positionable independently of the main machining head in a vertical machine as well.

With regard to the device, this object is achieved by an arrangement for toothing machining, with which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, preferably not more than 8°, in particular not more than 4°, the predominant directional component of the feed movement runs in the direction of the tool axis of rotation, and in particular the cutting edge has a greater directional component in the direction of the axis of rotation of the chamfering tool than in the plane of rotation orthogonal thereto, at least in its portion chamfering in the region at half the tooth height of the workpiece toothing.

As already described above with regard to the method according to the invention, the arrangement can be designed such that the end edge differing from the tooth end edge of the same tooth gap chamfered with the chamfering tool is chamfered with an additional chamfering tool which is rotationally driven by a third tool spindle. This variant can also be implemented regardless of whether one, or which, directional component of the feed movement predominates.

It can also be provided that the control device for chamfering be the same control device that also controls the toothing machining with the toothing machining tool. This variant can also be implemented regardless of whether one, or which, directional component of the feed movement predominates.

In a likewise preferred embodiment, it is provided that the control device be designed/programmed to control the chamfering to produce a course of the transition line between chamfer and flank that deviates from parallelity to the end face. This variant can also be implemented regardless of whether one, or which, directional component of the feed movement predominates.

A toothing machine used to carry out the method preferably also carries out a main toothing machining operation on the toothing machine itself; a transfer to a chamfering region of the toothing machine preferably takes place via a loading system such as a gantry loader, as described in more detail elsewhere. The advantages of a toothing machine according to the invention result from the above description of the method according to the invention.

The number of cutting edges on the chamfering tool is preferably not greater than four, in particular only two or only one. The working diameter of the chamfering tool relative to the pitch circle is preferably between one and four pitches of the toothing to be chamfered.

Further features, details, and advantages of the invention will be apparent from the following description with reference to the accompanying figures, wherein:

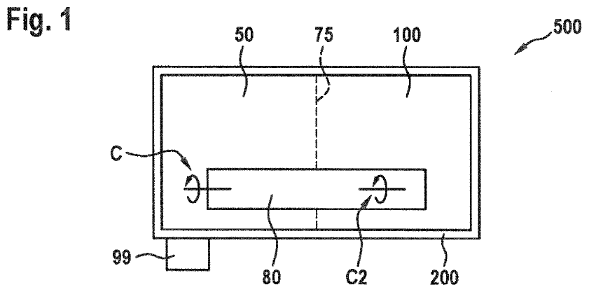

FIG. 1 schematically shows a toothing machine,

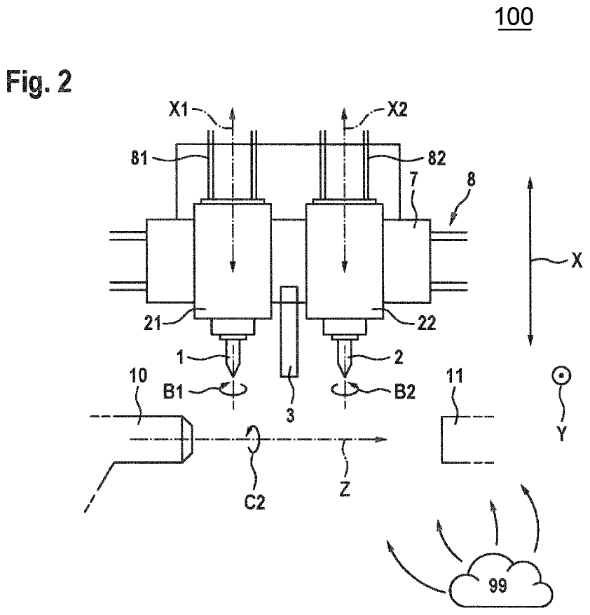

FIG. 2 schematically shows in a plan view a chamfering region of the toothing machine from FIG. 1,

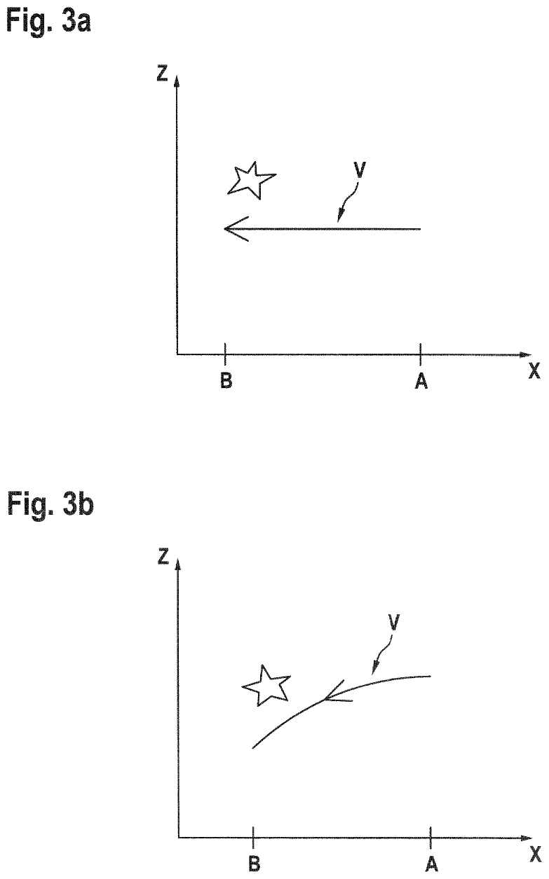

FIGS. 3A and 3B illustrate feed movements,

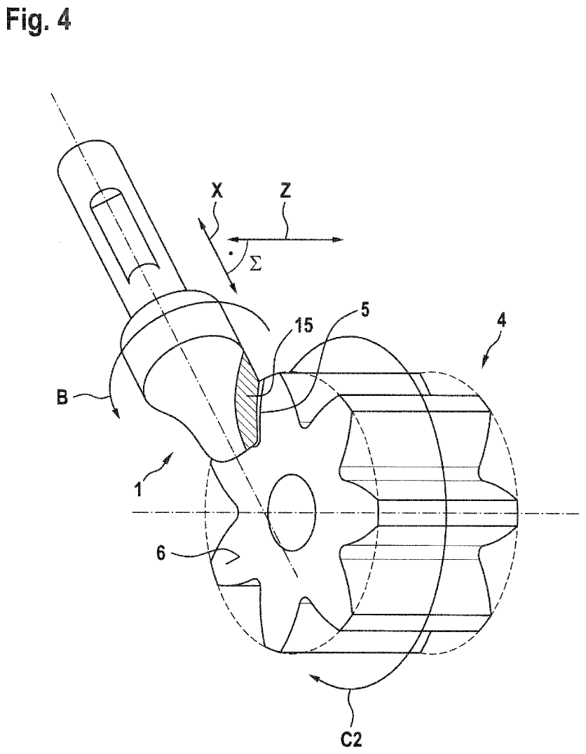

FIG. 4 shows a perspectival view of a chamfering machining operation,

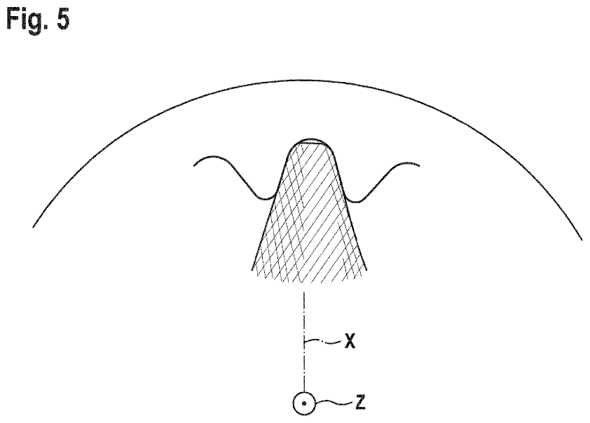

FIG. 5 shows a purely schematic illustration of an internal toothing chamfering,

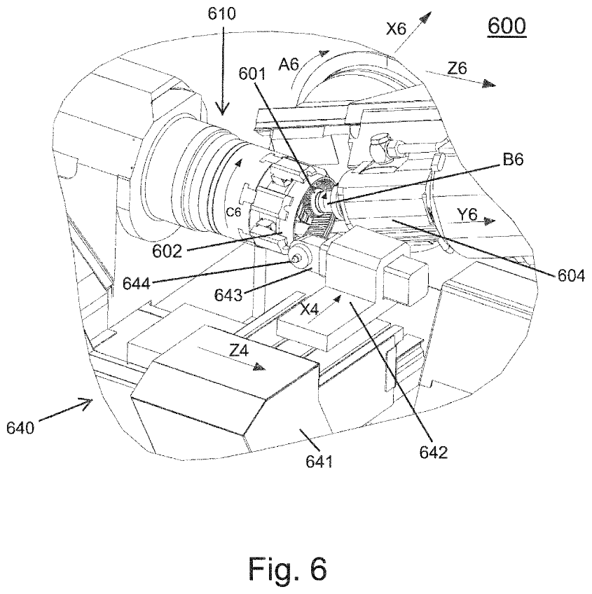

FIG. 6 shows part of a skiving machine with chamfering unit,

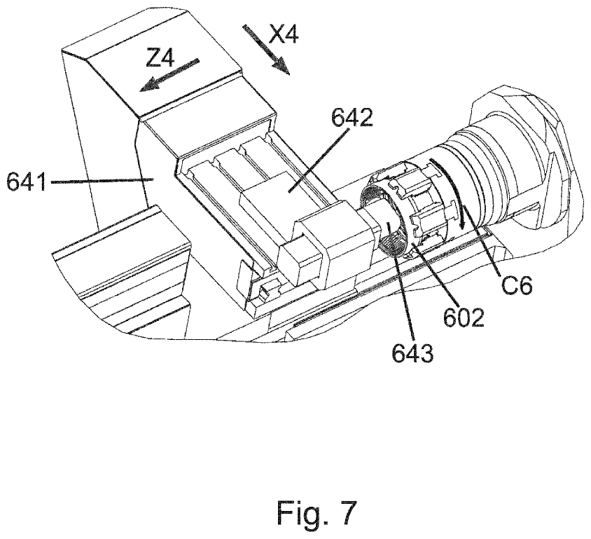

FIG. 7 shows the chamfering unit from FIG. 6 in machining mode, and

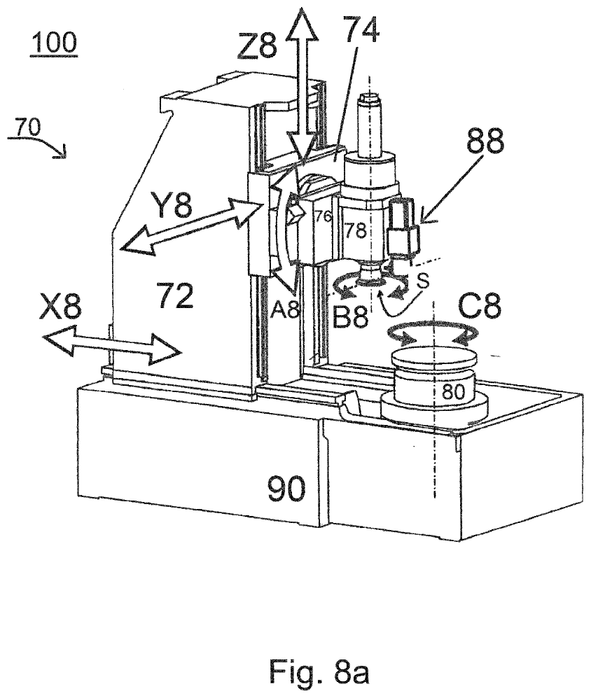

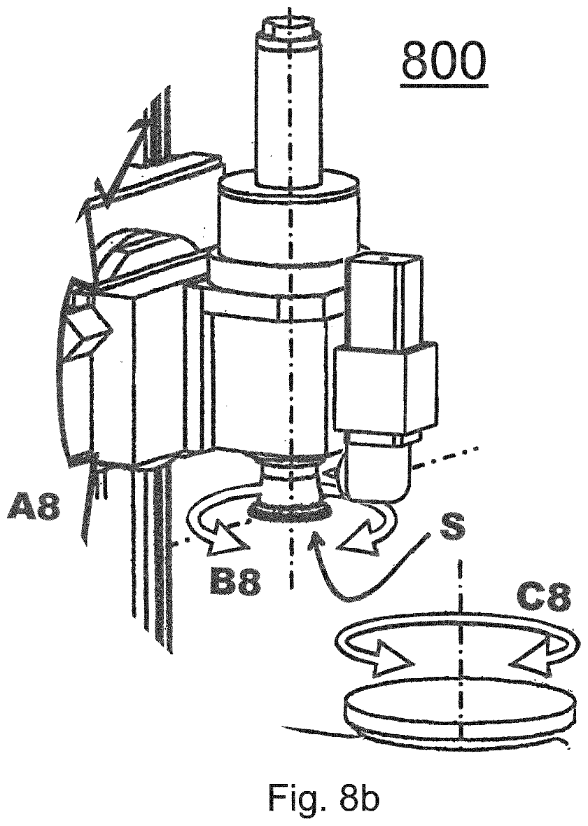

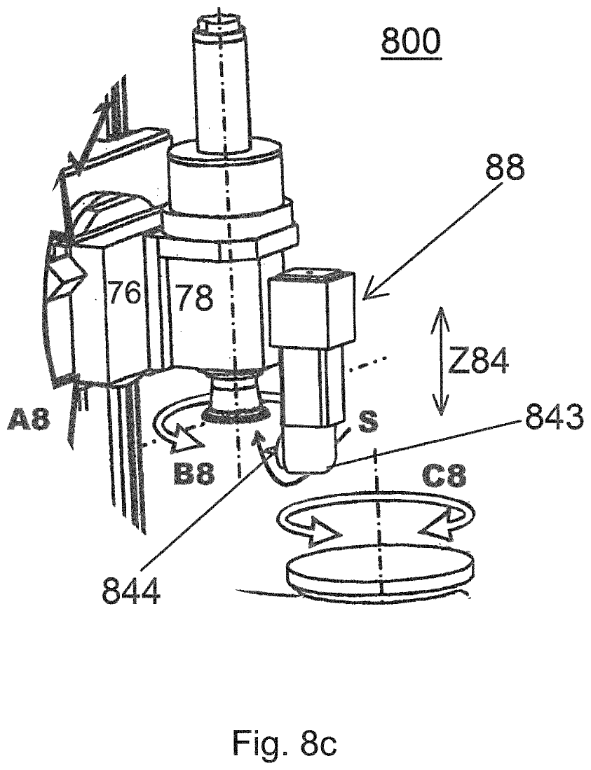

FIG. 8a, b, c show another gear skiving machine with chamfering unit as a whole, and partly in different positions.

In the embodiment now explained with reference to FIG. 1, a toothing machine 500, shown schematically, in the form of a horizontal machine is provided. In FIG. 1, a workpiece spindle axis of rotation C is schematically indicated on the side of a main machining station 50, and a workpiece spindle axis of rotation C2 on the side of a chamfering station 100. Both stations 50, 100 belong to the toothing machine 500, symbolized in FIG. 1 by a common frame 200, which can also be designed as a common machine bed, and a reloading system 80, which is only schematically indicated in FIG. 1 and is able to pick up a workpiece from the main workpiece spindle defining the (main) workpiece spindle axis C and transfer it to the workpiece spindle 10 associated with the (chamfering) workpiece spindle axis C2. The transfer thus takes place within the toothing machine 500, and the two workpiece spindle axes C and C2 run parallel and horizontally, preferably coaxially. A partition wall 75 can be provided between the main machining station 50 and the chamfering station 100. A tool head (not shown) with corresponding moving options for toothing machining is also provided on the main machining station 50. In the present case, the main machining station 50 is designed for gear skiving, but the invention is not limited to this; gear hobbing or gear shaping could, for example, also be carried out.

In FIG. 2, the chamfering station or chamfering region 100 of the toothing machine 500 is shown in a possible embodiment. On the workpiece side, the workpiece spindle 10 is shown with workpiece spindle axis C2, which runs in the Z-direction—here, horizontally. A tailstock 11 can be used opposite the workpiece spindle 10, preferably when shaft-shaped workpieces are to be machined.

A linear guide for a tool carriage 7, symbolized by two rails 8, runs parallel to the Z-axis. Two tool heads 21, 22 are arranged on the carriage 7, which are axially movable relative to the linear carriage 7 via a further linear guide, along (radial) axis X, with linear travel axes X1 and X2. The linear guides are symbolized by rails 81, 82. The chamfering tool axes of rotation are designated B1 and B2 in FIG. 2, and the chamfering tools are designated 1 and 2. In this embodiment, the linear axis/axes X (X1, X2) is/are also provided horizontally; the representation of FIG. 2 thus corresponds to a view from above. A centering sensor 3 is provided between the chamfering tools 1 and 2—here, with a pneumatic drive (not shown). With the centering sensor 3, the position of the tooth gaps of a toothing to be chamfered can be determined in a manner well known to those skilled in the art.

Also shown in FIG. 2 is a vertical axis Y, which forms a right-angled tripod with the linear axes Z and X. In the embodiment shown here, the height level of the spindle axes C2, B1, and B2 is provided at the same height, and there is no further axis of movement in the Y-direction. In other realizations, however, a vertical carriage could be provided via which the arrangement 7, 8 can be moved vertically.

In this realization, according to a preferred embodiment, the workpiece spindle axis C2 is horizontal as already explained, but in principle a vertical machine could also be provided. In this case, the linear mobility X could still be used as a radial movement to a toothing clamped on the workpiece spindle 10.

In the variant explained with reference to FIG. 2, the first chamfering tool 1 is used for chamfering the tooth end edge (in particular also in the tooth root region) on one tooth flank, e.g., the left tooth flank, and the other chamfering tool 2 is used for chamfering on the other tooth flank—for example, the right tooth flank. The direction of rotation of the spindle axes B1 and B2 is preferably controlled in opposite directions here, with a controller symbolized in FIG. 2 with the reference sign 99. In addition, the direction of rotation is adjusted in such a way that the tooth edge to be chamfered is cut from the inside away from the axial tooth center to the outside, in order to avoid generating burrs on the sides of the tooth flanks.

All spindle arrangements known to the person skilled in the art can be used as drive spindles, such as a high-frequency spindle; the interface between the chamfering tool and the spindle can be designed as an HSK interface. The two-rail linear guide is also only shown as an example; in concrete terms, only one rail could be provided, e.g., dovetail-shaped, on which a suitably shaped shoe slides. The toothing machine-internal reloading system 80 shown in FIG. 1 transfers a workpiece that has been machined with a toothing on the main station (main machining region) 50 to the workpiece spindle 10 of the chamfering region 100 of the toothing machine 500 without changing the axis orientation of the workpiece during transport.

FIG. 3A and B illustrate a feed movement during chamfering. Thus, in one operating mode, the controller 99 is designed to control the feed movement purely radially; the chamfering tool reduces the radial distance to the toothing to be chamfered during machining from a radial position to a radial position B.

In the operating mode shown in FIG. 3B, the controller 99 is designed to carry out the feed movement by superimposing a radial movement X and an axial movement Z, wherein the radial movement component predominates.

In both cases, by adjusting the feed movement, chamfering is possible even close to interfering contours, symbolized by a star in FIG. 3. If necessary, a purely axial feed movement can also be considered, especially if no interfering contours are to be taken into account, or even a superimposed feed movement with a predominantly axial component. At least one of these feed motion concepts is stored in the controller 99 and can be used.

In FIG. 4, the machining operation of the chamfering tool 1 is shown again in a perspectival view. In this embodiment, the workpiece axis of rotation C2 and the tool axis of rotation B1 are at an axis crossing angle of 90° due to their parallelity to the axes Z and X perpendicular to one another. In addition, in the embodiment shown, the axial distance of the rotation axes is 0, i.e., the extension of the axis of rotation B1 intersects the extension of the axis of rotation C2. In other embodiments, a small axial distance and/or a small deviation of the axle crossing angle from 90° can also be provided. In the variant shown, the front face 6 of the toothing 4 runs orthogonal to the workpiece axis of rotation C2. In cases of inclined end faces, it can also be provided that, instead of the orthogonality of the tool axis of rotation to the Z-axis, an orthogonality to the surface normal of an inclined end face be provided. To adjust the axis crossing angle, a tool head (20, 21, 22) could have an additional axis of rotation (not shown in FIG. 2).

The workpiece axis of rotation C2 and tool axis of rotation B1 are controlled synchronously by the controller 99, so that a cutting edge 15 of the chamfering tool 1 comes into cutting machining engagement with the tooth edge 5 of the workpiece toothing 4 and produces a chamfer there. The position of the cutting edge 15 is realized in workpiece-specific fashion such that, in the final machining position of completed feed movement on the toothing, a predetermined chamfer shape of the chamfer now formed is achieved, in place of the tooth end edge 5.

In this case, the transition line between the tooth flank and the chamfer can preferably not yet be formed to be parallel to the end face 6 as desired, for example, but deviates from this in such a way that such a parallel transition line results only after subsequent hard finishing to the final dimension of the workpiece toothing 5.

For the variant explained with reference to FIG. 2, the chamfering tools 1 and 2 are formed in such a way that only one tooth edge 5 is chamfered, but not the opposite tooth edge of the tooth gap. In another embodiment, however, a chamfering tool (with tool axis of rotation B) could also machine both tooth edges. Then the “double chamfering tool configuration” shown in FIG. 2 would no longer be required, and only one chamfering tool head (20) with tool axis of rotation (B) would be required.

To the extent that secondary burrs are still created by chamfering, e.g., on the front side 6, these could be removed by a deburring unit, not shown in the figures, such as a brush or brush arrangement.

The controller 99 controls the entire toothing machine 500, i.e., the main machining region 50 as well as the chamfering region 100. Changes in the machine axis settings during main machining 50 can thus be checked internally in the control system to determine whether corrections are required for the chamfering, and, if necessary, correction settings for the chamfering method can be made internally and automatically in the control system. In principle, however, it can also be provided that the chamfering described above be carried out on a separate chamfering station.

The chamfering technique described above has been described by way of example for chamfering external toothings, but it is also suitable for chamfering internally toothed workpieces (FIG. 5). For this purpose, a tool head/chamfering tool would penetrate into the space delimited by the contour of the internal toothing, as seen in projection onto the workpiece axis of rotation, e.g., by means of a corresponding projection of the spindle head, which is preferably designed with an angular gear mechanism. The axes of movement—double, as shown in FIG. 2, or only single for a chamfering tool—could be retained.

In the following, using FIGS. 6 to 8, specific designs of toothing machines are described which produce/machine internal toothings and are equipped with a chamfering unit which operates according to one or more aspects as explained above.

As can be seen in FIG. 6, which shows a relevant detail of a gear skiving machine 600, this gear skiving machine 600 is designed as a so-called horizontal machine, with a horizontally arranged workpiece spindle axis of rotation C6. On the workpiece side, a workpiece 602 in the form of an internal toothing is clamped onto the workpiece spindle 610.

On the tool side, a skiving wheel 601 is provided, as the main machining tool, with tool axis of rotation B6, which is arranged in the usual way on a tool head 604 and produces or machines the internally toothed workpiece 602 in the gear skiving process. The tool head 604 is linearly movable along a linear axis Y6, and a carriage arrangement provided for realizing this linear movement Y6 is pivotably arranged with pivot axis A6. The support structure enabling this pivoting around axis A6 is provided in the form of a cross-carriage, with which two further linear travel axes X6 and Z6 are realized. In the design described by way of example, the Z6 axis runs parallel to the workpiece spindle axis C6, and the X6 axis is a radial infeed axis and is parallel to the pivot axis A6.

In the foreground of FIG. 6, a chamfering unit 640 is shown that is also realized as a cross-carriage arrangement. A first carriage 641 can move along a guide rail arrangement, provided on the machine support side, along the linear movement axis Z4, which runs parallel to the workpiece axis of rotation C6. The first carriage 641 forms a guide rail arrangement for a carrier 642 carried thereby, which can move along a further radial axis X4 relative to the first carriage 641, wherein the axis X4 is orthogonal to the axis Z4. The chamfering head 643 held by the second carriage 642 can be positioned relative to the internally toothed workpiece 602 via these two axes X 4 and Z4.

In the position shown in FIG. 6, the chamfering tool 644, which is mounted on the chamfering tool head 643 so as to be capable of being driven to rotate about its axis, is inactive, and a skiving machining is carried out by the skiving wheel 601. Depending upon the dimensions of the tool-side working tools (601, 641), the skiving and chamfering machining can also take place simultaneously, depending upon the dimensions of the workpiece; for the sizes specifically shown here, sequential machining is provided. The chamfering operation is shown in FIG. 7, in which a smaller detail of the toothing machine 600 is shown enlarged from a different angle. In the illustration of FIG. 7, the chamfering tool 644 chamfers the tooth edges of the internally toothed workpiece 602 on the axial end side facing the tool side. The machining of the tooth edges on the axial end side remote from the tool is carried out under changed relative positioning between the chamfering tool 641 and workpiece 602. To do this, the chamfering tool 641 is first disengaged using the X4 axis; it is then moved axially along the Z4 axis to the level of the other axial end side and then fed back using the X4 axis for the chamfering there. In addition to positioning, the X4 and/or Z4 axes can also be used as feed axes during chamfering.

FIG. 8a shows a further exemplary embodiment in the form of another toothing machine 800, which is also configured as a skiving machine with skiving wheel S. The toothing machine 800 is designed as a vertical machine, with a vertical workpiece axis of rotation designated here as C8, wherein the internally toothed workpiece itself is not shown, but only the workpiece table.

On the tool side, the tool axis of rotation is designated B8, and the tool head is designated 78. The latter is in turn pivotable with pivot axis A8, and can be moved tangentially by means of a pivoted carriage 76 (axis Y8). The pivot unit that realizes the pivoting with axis A8 can also be moved vertically with linear axis Z8, and can also be moved linearly with radial axis X8 towards or away from the workpiece table. Thus, the skiving wheel S has for its positioning in relation to a workpiece clamped on the workpiece table three linear and one rotary NC axes for its positioning, infeed, and advance during skiving.

In this exemplary embodiment, the tool head 78 carries the chamfering unit 88 in piggyback fashion. This means that the chamfering head 843 can move over all movement axes X8, Z8, A8, Y8, as can the skiving head 78. Similar to the construction shown in FIG. 7, the chamfering head 843 carrying the chamfering tool 844 is again axially movable relative to the tool head 78 via the movement axis Z84. This axis could be an NC axis, which is also used in chamfering machining, or a pure positioning axis, via which the chamfering head 843 is movable from a retracted first position (FIG. 8b), in which an internal toothing machining is not impaired by the skiving wheel S, to an extended second position (FIG. 8c), in which its chamfering machining is not impaired by the skiving wheel S as a tool-side interfering contour. In this configuration, the main machining with the skiving wheel S takes place at an axis crossing angle to the workpiece axis of rotation, and the chamfering does not take place at the same axis crossing angle, but, rather, either with axes Z84 and C8 parallel to the axis or at a smaller axis crossing angle compared to that of the skiving.

In this exemplary embodiment, the chamfering unit 80 is arranged on the side, facing the workpiece, of the main machining head 78, but a lateral arrangement is also conceivable. Accordingly, the orientation of the axis of rotation of the chamfering tool 844 can preferably be radial, i.e., can run parallel to the X8 axis, but can also be tangential, i.e., parallel to the Y8 axis (while still engaging laterally, i.e., radially positioned with respect to the engagement region). For machining external toothings using the toothing machine 800, the chamfering tool 844 would point with its tip in the direction of the workpiece rotary table and would thus be arranged opposite to the illustration in FIG. 8c. For this purpose, the chamfering tool head 843 would either be pivoted by 180°, with respect to its mounting, in the chamfering unit 80 or would be dismantled and remounted in an orientation changed by 180°. Also conceivable is an axis crossing angle created by a constructive relative arrangement between the axes B8 and Z84, so that, when Z8 and Z84 are set in parallel, the skiving wheel S is pivoted by pivoting around this axis crossing angle outside any risk of collision.

In all variants of FIGS. 6 to 8, the chamfering tool could be driven by a small-dimensioned direct drive, but an indirect drive is preferred, which is connected via a gear mechanism or a belt transmission to the rotary shaft of the unit, which is coaxial with the workpiece axis of rotation.

The invention is not limited to the details and embodiments described in the above description of the figures. Rather, the individual features of the above description and of the following claims may be important, individually or in combination, for implementing the invention in its various embodiments.

1. A method for toothing machining, in which, on a toothing machine (500) controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle (10) arranged at a second machine position, with synchronized rotation of the workpiece and a workpiece-specific chamfering tool (1) for the workpiece driven rotationally by a second tool spindle, and with a feed movement (V) between the chamfering tool and the workpiece, a chamfer is produced by cutting with a cutting edge (15) of the chamfering tool on a tooth end edge (5) of a tooth flank of the workpiece toothing, wherein, during chamfering, the axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face (6) of the workpiece adjacent to the machined tooth end edge differs from 90° by not more than 12°, the predominant directional component of the feed movement (V) runs in the direction of the tool axis of rotation, and the cutting edge has a greater directional component in the direction of the axis of rotation of the chamfering tool than in the plane of rotation orthogonal thereto, at least in its portion chamfering in the region at half the tooth height of the workpiece toothing.

2. The method according to claim 1, in which the tooth end edge that is different from the tooth end edge of the same tooth gap chamfered with the chamfering tool is chamfered with an additional chamfering tool which is rotationally driven by a third tool spindle.

3. The method according to claim 1 in which, when chamfering with the chamfering tool and/or the additional chamfering tool, the directional component of the cutting speed parallel to the workpiece axis is directed away from the axial center of the workpiece toothing.

4. The method according to claim 1 in which the chamfering is controlled with the same control device as the toothing machining with the toothing machining tool.

5. The method according to claim 4, in which at least one control parameter of the chamfering is incorporated into the chamfering as a function of a change in a control parameter of the toothing machining with the toothing machining tool.

6. The method according to claim 5, in which the control parameter during chamfering influences the course of the transition line between tooth flank and chamfer, taking into account an allowance to be removed in a subsequent hard finishing operation compared to a final geometry of the workpiece toothing.

7. The method according to claim 1 in which the chamfering is carried out in the continued presence of a cooling and/or lubricating fluid originating from the toothing machining by the toothing machining tool.

8. The method according to claim 1 in which burrs created by chamfering are removed with an additional burr removal device.

9. The method according to claim 1 in which the control device controls the chamfering to produce a course of the transition line between chamfer and flank, which deviates from parallelity to the end face.

10. The method according to claim 1 in which the axis crossing angle is variably adjustable.

11. The method according to claim 2 in which the second and the third tool spindles are carried by a common carrier which has at least two degrees of freedom of movement.

12. The method according to claim 1 in which the machined and chamfered toothing is an internal toothing.

13. An arrangement for toothing machining, with which, on a toothing machine controlled by a control device, a toothing is produced or machined, on a workpiece clamped on a workpiece spindle arranged at a first machine position, by a toothing tool driven rotationally on a first tool spindle, and, subsequently, in the same workpiece clamping operation or in a clamping operation of the machined toothed workpiece on a workpiece spindle arranged at a second machine position, with synchronized rotation of the workpiece and a workpiece-specific chamfering tool driven rotationally by a second tool spindle, and with a feed movement between the chamfering tool and the workpiece, a chamfer is produced by cutting with a cutting edge of the chamfering tool on a tooth end edge of a tooth flank of the workpiece toothing, wherein, during chamfering, an axial distance between the axes of rotation of the workpiece and the chamfering tool is not greater than half a pitch of the workpiece toothing, the axis crossing angle between the tool axis of rotation and the workpiece axis of rotation and/or the axis crossing angle between the tool axis of rotation and a surface normal to the end face of the workpiece adjacent to the machined tooth end edge differs from 90° by not more than 12°, the predominant directional component of the feed movement runs in the direction of the tool axis of rotation, and in particular the cutting edge has a greater directional component in the direction of the axis of rotation of the chamfering tool than in the plane of rotation orthogonal thereto, at least in its portion chamfering in the region at half the tooth height of the workpiece toothing.

14. (canceled)

15. A toothing machine with a workpiece spindle arranged at a first machine location and a first tool spindle for rotationally driving a toothing tool for producing or machining a toothing on a workpiece clamped on the workpiece spindle, as well as with an arrangement for chamfering according to claim 13.

16. The toothing machine according to claim 15, with coaxial first and second workpiece spindle axes and a linear movement axis running parallel thereto of a reloading system transferring workpieces from the first to the second workpiece spindle.

17. The method according to claim 8 wherein said additional burr removal device comprises a brush.

18. The method according to claim 10 wherein the axis crossing angle is variably adjustable via a rotary axis.

19. The method according to claim 18 wherein the rotary axis is NC-controlled.

20. The method according to claim 1 wherein the axis crossing angle between the tool axis of rotation and the workpiece axis of rotation and/or the axis crossing angle between the tool axis of rotation and a surface normal to the end face (6) of the workpiece adjacent to the machined tooth end edge differs from 90° by not more than 8°.

21. The method according to claim 20 wherein the axis crossing angle between the tool axis of rotation and the workpiece axis of rotation and/or the axis crossing angle between the tool axis of rotation and a surface normal to the end face (6) of the workpiece adjacent to the machined tooth end edge differs from 90° by not more than 4°.
